(19) United States
(12) Patent Application Publication
(10) Pub. No.: US 2013/0075318 A1
(43) Pub. Date: Mar. 28, 2013

(54) Apparatus for Isolating Rare Cells from Blood Samples

(71) Applicants: Xiaojing Zhang, Austin, TX (US); Yu-Yen Huang, Austin, TX (US); Ting Shen, Austin, TX (US); Kazunori Hoshino, Austin, TX (US); Jonathan Uhr, Dallas, TX (US); Eugene Frenkel, Dallas, TX (US)

(72) Inventors: Xiaojing Zhang, Austin, TX (US); Yu-Yen Huang, Austin, TX (US); Ting Shen, Austin, TX (US); Kazunori Hoshino, Austin, TX (US); Jonathan Uhr, Dallas, TX (US); Eugene Frenkel, Dallas, TX (US)

(21) Appl. No.: 13/241,553

(22) Filed: Sep. 23, 2011

(51) Int. Cl. B03C 1/02

(52) U.S. Cl. 210/222

(57) ABSTRACT

An apparatus for isolating rare cells from a blood sample is disclosed. The apparatus includes a reservoir for supplying the blood sample and a pump for receiving the blood sample. The apparatus also includes a microchip and a set of magnets. The microchip has a microchannel formed between the microchip and a glass slide. The microchannel is connected between the reservoir and the pump to allow the blood sample to flow from the reservoir to the pump. The set of magnets is located adjacent to the glass slide to form a magnetic gradient along the glass slide on which rare cells can be isolated from the blood sample.

### BACKGROUND OF THE INVENTION

1. Technical Field

The present invention relates to rare cells detection in general, and in particular to an apparatus for isolating rare cells and/or proteins from patient blood samples.

2. Description of Related Art

The detection of rare cells, such as circulating tumor cells (CTCs) and malignant stem cells, or disease specific proteins in patient blood samples is at the frontier of next generation diagnostic tools for determining the existence of progressive disease, the status of disease activity, etc. In particular, the amount of CTCs appeared in a patient blood sample has been shown to have a strong correlation with the survival rate of the patient. Thus, early detection of CTCs in patient blood sample can be the key to improving curing rates.

The most challenging aspect of CTC detection is that the number of CTCs tend to be very small in relation to the size of a patient blood sample. The cytometric method is the most commonly utilized method for CTC detection. For highly specific separation of CTCs, it is more desirable to use the immunoassay-based detection method in which antibodies for tumor-specific markers are utilized to label target CTCs. Other methods include the morphological separation method in which size or density is utilized to isolate CTCs from leukocytes that are smaller than the CTCs. Some of the above-mentioned methods leave a large amount of non-CTCs that are morphologically similar to CTCs, and fail to account for CTCs that are as small as leukocytes. As a result, an additional screening process, such as immunofluorescence, is required.

Consequently, it would be desirable to provide an improved method and apparatus for isolating rare cells and/or disease specific proteins from patient blood samples.

### SUMMARY OF THE INVENTION

In accordance with a preferred embodiment of the present invention, an apparatus for isolating rare cells from a blood sample includes a reservoir for supplying the blood sample and a pump for receiving the blood sample. The apparatus also includes a microchip and a set of magnets. A microchannel can be formed between the microchip and a glass slide. The microchannel is connected between the reservoir and the pump to allow the blood sample to flow from the reservoir to the pump. The set of magnets is located adjacent to the glass slide to form a magnetic gradient along the glass slide on which rare cells can be isolated from the blood sample.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of an apparatus for isolating rare cells from patient blood samples, in accordance with a preferred embodiment of the present invention;

FIG. 2 is an isometric view of a microchannel within the apparatus from FIG. 1, in accordance with a preferred embodiment of the present invention;

FIG. 3 is a diagram illustrating free nanoparticles and various rare cells being isolated in three different zones of a glass slide, in accordance with a preferred embodiment of the present invention;

FIG. 4 is a diagram of a motorized rotational aim for rotating a microchip, in accordance with a preferred embodiment of the present invention; and

FIG. 5 is a diagram of a rotatable holder for holding a reservoir, in accordance with a preferred embodiment of the present invention.

### DETAILED DESCRIPTION OF A PREFERRED EMBODIMENT

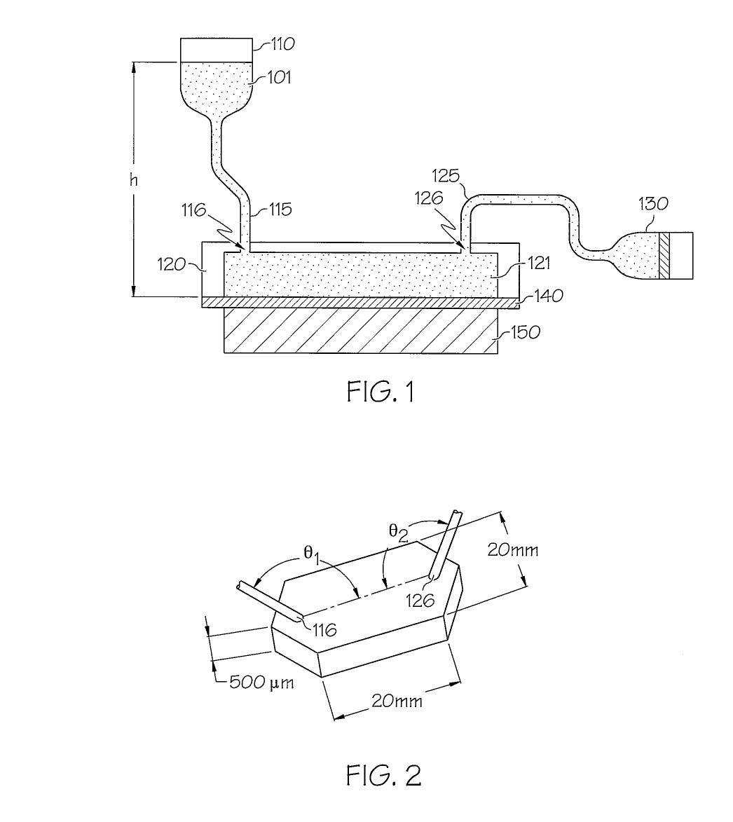

Referring now to the drawings and in particular to FIG. 1, there is depicted a diagram of an apparatus for isolating rare cells from patient blood samples, in accordance with a preferred embodiment of the present invention. As shown, an apparatus 100 includes a reservoir 110, a microchip 120, a syringe pump 130, and a glass slide 140. Along with glass slide 140, a microchannel 121 is formed within microchip 120. Basically, microchip 120 is sealed by glass slide 140 located on top of a set of magnets 150. Microchannel 121 includes an inlet 116 and an outlet 126. Reservoir 110 is connected to inlet 116 of microchannel 121 via a tube 115. Similarly, syringe pump 130 is connected to outlet 126 of microchannel 121 via a tube 125.

Microchip 120 can be made by a molding technique using Polydimethyl-siloxane (PDMS) (such as Sylgard 184 manufactured by Dow Corning, Midland, Mich.). Initially, a thin film of photoresist (such as SU-8 photoresist manufactured by MicroChem, Newton, Mass.) is spin-coated on a flat silicon wafer. The photoresist is then exposed to an ultra-violet (UV) light through a photomask. After the exposure, the unexposed areas of the photoresist can be removed by using a liquid developer via a development step. The exposed area of the photoresist, which remains on the silicon wafer after the development step, can be served as a negative master for making microchips. Next, a mixture of PDMS and curing agent (10 parts of PDMS to 1 part of curing agent) is poured onto the photoresist and the silicon wafer (i.e., the negative master). The PDMS mixture is cured after a period of time has lapsed and forms a elastic body. After being peeled off from the photoresist and the silicon wafer, the elastic body can be served as a microchip such as microchip 120. The microchip can be cut to a desirable shape and then bonded on a glass slide, such as glass slide 140, to form a microchannel such as microchannel 121. The preferable shape and dimensions of microchannel 121 are shown in FIG. 2. Glass slide 140 is preferably 150 mm thick.

The shape of microchannel 121 and the access angles (θ₁, θ₂) of inlet 116 and outlet 126 can affect the flow distribution of blood samples within microchannel 121. Fast flow of blood samples at certain areas within microchannel 121 should be avoided because fast flow may cause mechanical damage to rare cells within the blood samples. Also, non-uniform flow may create stagnation points that can easily keep unwanted blood cells from being flushed away. Access angles of 90° for both inlet 116 and outlet 126 (i.e., θ₁=θ₂=90°) are most preferable in order to maintain equalized (laminar) blood flow throughout microchannel 121.

For the purpose of isolating rare cells from blood sample 101, blood sample 101 can be injected into microchannel 121 via reservoir 110. The flow rate of blood sample 101 through microchannel 121 is regulated by syringe pump 130 at preferably 2.5° mL/h Syringe pump 130 may draw blood sample 101 from microchannel 121 in order to minimize the inside pressure of microchannel 121.

Blood cells are typically denser than their medium (such as buffer solution, blood plasma, etc). In order to avoid stagnation of blood cells, reservoir 110 is located higher than microchip 120 and syringe pump 130. Preferably, reservoir 110 is located approximately 100 mm higher than microchip 120. Reservoir 110 is open to the atmosphere such that the inside pressure of microchannel 121 is governed by the density of blood sample (ρ), acceleration of gravity (g) and the height of blood sample level in reservoir 110 in relation to microchannel 121 (h). Assuming ρ=1.05 g/mL, the pressure of blood sample 101 within microchannel 121 is approximately 0.01 atm. This low-pressure configuration minimizes the pressure of blood sample 101 within microchannel 121 as well as the risk of blood sample leakage from microchannel 121. The low-pressure configuration also enables the usage of a reversible bonding technique, which allows microchannel 121 to form between microchip 120 and glass slide 140.

Before being placed in reservoir 110, blood sample 101 is initially combined with magnetic nanoparticles that are functioned as antibodies to the surface of epithelial cell adhesion molecule (EpCAM). The magnetic nanoparticles can be Fe₃O₄ nanoparticles (such as Ferrofluid® manufactured by Veridex, LLC). The sizes of the magnetic nanoparticles are preferably in the order of 100 nm.

After the rare cells within blood sample 101 have been “labeled” or attached with the magnetic nanoparticles, the rare cells can be attracted by magnets 150 as blood sample 101 is being pumped through microchannel 121. As a result, the rare cells in blood sample 101 are collected on glass slide 140.

It is very likely that some magnetic nanoparticles are not bonded to any rare cells. But if the unattached or free nanoparticles are aggregated at the same area on glass slide 140 as the rare cells, the task of cell observation will become very difficult. Thus, a gradient magnetic field distribution should be provided by magnets 150 to allow the free nanoparticles to be isolated at one end of glass slide 140 while the rare cells are isolated at the other end of glass slide 140.

There are at least three methods to provide a gradient magnetic field distribution along the length of glass side 140. The first method is to use an array of magnets with ascending (or descending) magnetic strengths. The second method is to place the magnets in tilted angles in order to make the desired gradient magnetic field. The third method is to place various spacers between magnets.

Instead of using magnets 150, surface functionalization of microchannel 121 (i.e., microchip 120 along with glass slide 140) can be utilized to attract and capture rare cells. To do that, microchip 120 and glass slide 140 will be treated with O₂ plasma at 70 W for 15 seconds and is then promptly immersed in a 4% solution of (3-mercaptopropyl) trimethoxysilane (85% Acros Organics) in ethanol for 30 minutes, held in a nitrogen environment. Microchip 120 and glass slide 140 are then be rinsed with ethanol and allowed to react with a solution of 0.28% N-(y-maleimidobutyryloxy) succinimide ester (GMBS) in ethanol for 15 minutes, at which point microchip 120 and glass slide 140 will be rinsed with PBS. 10 μg/mL of neutravidin in PBS is then introduced, and after 30 minutes, the microchip 120 and glass slide 140 are rinsed with PBS again, followed by the functionalization chemistry step, for example, 10 μg/mL biotinylated anti-EpCAM in PBS for 30 minutes. After a final PBS rinse, microchip 120 and glass slide 140 will be fully functionalized and ready for assembly to form microchannel 121.

Functionalized microchannel 121 can allow a distribution of rare cells to be collected along a length of glass slide 140. The distribution can be random, gradient, periodic, etc.

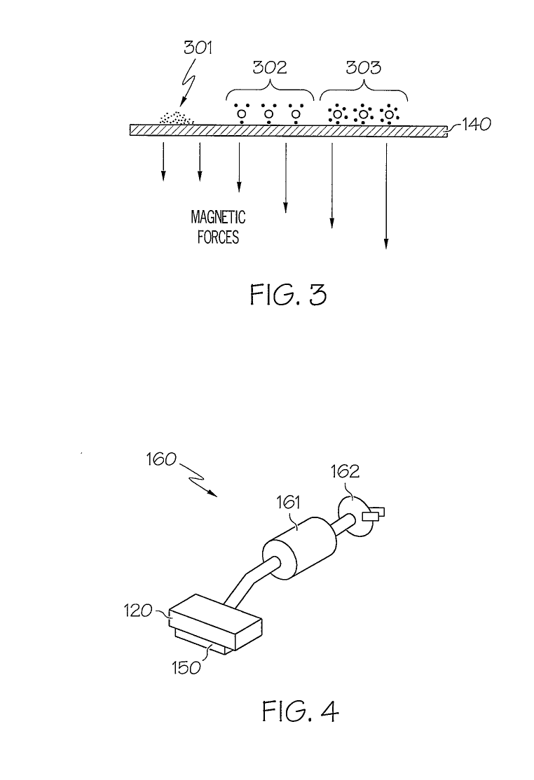

In addition, different types of rare cells can be “labeled” with different amount of magnetic nanoparticles to allow them to be collected at different zones of glass slide 140. For example, as shown in FIG. 3, free nanoparticles 301, rare cells 302 and rare cells 303 are collected in three different zones of glass slide 140. After all rare cells have been isolated from blood sample 101, glass slide 140 can be removed from microchannel 121 for cell observation under a standard optical microscope.

When microchannel 121 is being placed in an upright (i.e., vertical) position, relatively heavier red blood cells (RBCs) will fall to the bottom of microchannel 121 so that rare cells can be attracted to magnets 150 more easily. However, in order to have better separation, magnetic force and gravity have to be in opposite direction by placing microchannel 121 in a flipped position with magnets 150 located on top of glass slide 140. But if the magnetic force is not strong enough to attract rare cells when microchannel 121 is in a flipped position, gravity can be directed in the same way as the magnetic force in order to help attracting rare cells to glass slide 140.

Typically, magnetic force is inversely proportional to the square of distance. In an upright position, rare cells are made closer to magnets 150 by gravity. After rare cells are close enough to magnets 150, microchannel 121 can be rotated to a flipped position, so that rare cells are held by magnets 150, while other cells are separated by gravity. A continuous flip-and-flop motion to alternate microchannel 121 between an upright position and a flipped position during operation can make rare cells isolation more effective.

As shown in FIG. 4, microchip 120 along with magnets 150 are supported by a motorized rotational arm 160 to perform controlled rotation during the separation process. The orientation of microchip 121 can be rotated by rotational arm 160 having a rotary motor 161 and an encoding sensor 162 for controlling the angles of rotational arm 160 in a preferred manner.

If the center of rotation is located within microchannel 121, an excessive length of connecting tubes (such as tubes 115 and 125 from FIG. 1) may cause blood sample 101 to stagnate within the connecting tubes. It is more preferable to place the center of rotation between reservoir 110 and microchannel 121. This placement allows easier rotation of microchannel 121. The relative positions of magnets 150 change according to microchannel 121's angle (i.e., upright, tilted or flipped), and no excessive connecting tube is needed in the upright position and tilted position. The above-mentioned rotating motion can also be used to generate a centrifugal force that can sort cells with different sizes and densities.

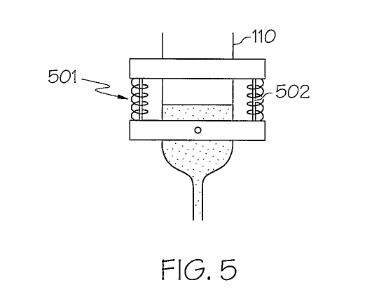

Usually, a large tension is applied on the connecting tubes at their corresponding connecting parts. In order to reduce the tension of the connecting tubes, it is desirable to secure reservoir 110 by a rotatable, sliding holder as shown in FIG. 5. Reservoir 110 is supported by springs 501, 502 to allow reservoir 110 to be freely rotated, which absorbs the tension applied between microchannel 121 and reservoir 110 via the connecting tubes.

Sedimentation speed of RBCs are dependent on the density of RBC. By knowing the RBC density distribution, the precise timing for the rotational motion can be determined RBC density distribution can be calculated as follows:
a. Calculate flow vector distribution in a microchannel (either theoretical calculation or computational fluid dynamics software can be used).
b. Divide the microchannel into multiple small control volumes (such as 100×100 rectangular areas).
c. For each control volume, initial blood density is measured.
d. For each control volume, sedimentation speed is measured.
e. Flow of RBC=blood sedimentation+flow field
   RBC density distributions can be updated using the current densities and the RBC flow.

As has been described, the present invention provides an apparatus for isolating rare cells and proteins from patient blood samples.

While the invention has been particularly shown and described with reference to a preferred embodiment, it will be understood by those skilled in the art that various changes in form and detail may be made therein without departing from the spirit and scope of the invention.

What is claimed is:

1. An apparatus for isolating rare cells in blood samples, said apparatus comprising:
a reservoir for supplying a blood sample;
a pump for receiving said blood sample;
a microchip having a microchannel formed between said microchip and a glass slide, wherein said microchannel is connected between said reservoir and said pump to allow said blood sample to flow from said reservoir to said pump; and
a plurality of magnets located adjacent to said glass slide to form a gradient magnetic field distribution along a length of said glass slide on which rare cells can be collected.

2. The apparatus of claim 1, wherein said microchannel has an inlet and outlet having an access of angle 90°.

3. The apparatus of claim 1, wherein said microchannel has a hexagonal shape.

4. The apparatus of claim 1, wherein said magnets have various magnetic strengths.

5. The apparatus of claim 1, wherein said apparatus further includes a rotational arm to rotate the orientation of said microchannel and said magnets.

6. The apparatus of claim 5, wherein said microchannel and said magnets are placed alternatively between a vertical position and a flipped position.

7. An apparatus for isolating rare cells in blood samples, said apparatus comprising:
a reservoir for supplying a blood sample;
a pump for receiving said blood sample;
a microchip having a functionalized microchannel formed between said microchip and a glass slide, wherein said functionalized microchannel is connected between said reservoir and said pump to allow said blood sample to flow from said reservoir to said pump, wherein said functionalized microchannel enables a distribution of rare cells along a length of said glass slide on which rare cells can be collected.

8. The apparatus of claim 7, wherein said microchannel has an inlet and outlet having an access of angle 90°.

9. The apparatus of claim 7, wherein said microchannel has a hexagonal shape.

10. The apparatus of claim 7, wherein said magnets have various magnetic strengths.

11. The apparatus of claim 7, wherein said apparatus further includes a rotational arm to rotate the orientation of said microchannel.

12. The apparatus of claim 11, wherein said microchannel is placed alternatively between a vertical position and a flipped position.
